(19) United States
(12) Patent Application Publication
(10) Pub. No.: US 2012/0137281 A1
(43) Pub. Date: May 31, 2012

(54) METHOD AND APPARATUS FOR INSTALLING PROGRAMS ON A COMPUTER PLATFORM

(75) Inventors: Roman Kleiner, London (GB); Timothy Gover, London (GB); Stephen Bannister, London (GB)

(73) Assignee: NOKIA CORPORATION, Espoo (FI)

(21) Appl. No.: 13/139,472

(22) PCT Filed: Dec. 2, 2009
(86) PCT No.: PCT/IB09/55461

§ 371 Date: Sep. 29, 2011

(30) Foreign Application Priority Data
Dec. 12, 2008 (GB) 0822749.8

(51) Int. Cl. G06F 9/445; G06F 17/30

(52) U.S. Cl. 717/174

(57) ABSTRACT

In accordance with an example embodiment of the present invention, a software installer framework module providing an installation interface to cause an obtained computer program to be installed on to a computer platform is provided, as well as a plurality of installer plug-in modules, being at least one installer plug-in module for each type of computer program to be installed, each installer plug-in module being arranged such that in use it is able to install and/or uninstall the type of computer program to which it relates to and/or from the computer platform. In use, an install or uninstall command in relation to a specific computer program is received at the software installer framework module via the installation interface, and the software installer framework module selects one of the plurality of installer plug-in modules in dependence on a type of the specific computer program, the selected installer plug-in module then undertaking the installation or un-installation of the specific computer program to or from the computer platform.

### TECHNICAL FIELD

Examples of the present invention relate to a method and apparatus for installing programs on a computer platform, and in particular to such a method and apparatus wherein programs can be installed using an installer framework.

### BACKGROUND TO THE INVENTION

Generally in a computer system, different types of executable code can be installed on the system, and depending on the operating system type the installation process for the executable is determined in dependence on the type of the executable code itself.

### SUMMARY OF THE INVENTION

Various examples of the invention are set out in the claims.

According to a first aspect of the invention there is provided an apparatus, comprising: a) a software installer framework module providing an installation interface to cause an obtained computer program to be installed on to a computer platform; and b) a plurality of installer plug-in modules, being at least one installer plug-in module for each of one or more types of computer program to be installed, each installer plug-in module being arranged such that in use it is able to install and/or uninstall the type of computer program to which it relates to and/or from the computer platform; wherein, in use, an install or uninstall command in relation to a specific computer program is received at the software installer framework module via the installation interface, and the software installer framework module selects one of the plurality of installer plug-in modules in dependence on a type of the specific computer program, the selected installer plug-in module then undertaking the installation or un-installation of the specific computer program to or from the computer platform.

According to a second aspect of the invention there is provided an apparatus, comprising: an installer plug-in module for use with the apparatus of any of the preceding claims, the installer plug-in module being arranged in use to receive an install or un-install command from the software installer framework module, and to install or un-install a specific computer program of a particular type in dependence on the received command, where the installer plug-in module is arranged to install or uninstall computer programs of a single specific type.

According to a third aspect of the invention there is provided an apparatus, comprising: at least one processor; and at least one memory including computer program code, the at least one memory and the computer program code configured to, with the at least one processor, cause the apparatus to perform at least the following: a) receive an install or uninstall command in relation to a specific computer program at an installation interface provided by a software installer framework module provided on the apparatus; b) select, in dependence on a type of the specific computer program, one of a plurality of installer plug-in modules, being at least one installer plug-in module for each of one or more types of computer program to be installed, each installer plug-in module being arranged such that in use it is able to install and/or uninstall the type of computer program to which it relates to and/or from the apparatus; and c) the selected installer plug-in module then undertaking the installation or un installation of the specific computer program to or from the apparatus.

According to a fourth aspect of the invention there is provided an apparatus, comprising: at least one processor; and at least one memory including computer program code, the at least one memory and the computer program code configured to, with the at least one processor, cause the apparatus to perform at least the following: operate an installer plug-in module, the installer plug-in module being arranged in use to receive an install or un-install command from the software installer framework module, and to install or un-install a specific computer program of a particular type in dependence on the received command, where the installer plug-in module is arranged to install or uninstall computer programs of a single specific type.

According to a fifth aspect of the invention there is provided a method, comprising: a) receiving an install or uninstall command in relation to a specific computer program at an installation interface provided by a software installer framework module provided on a computer platform; b) selecting, in dependence on a type of the specific computer program, one of a plurality of installer plug-in modules, being at least one installer plug-in module for each of one or more types of computer program to be installed, each installer plug-in module being arranged such that in use it is able to install and/or uninstall the type of computer program to which it relates to and/or from the computer platform; and c) the selected installer plug-in module then undertaking the installation or un installation of the specific computer program to or from the computer platform.

According to a sixth aspect of the invention there is provided a method, comprising: operating an installer plug-in module, the installer plug-in module being arranged in use to receive an install or un-install command from the software installer framework module, and to install or un-install a specific computer program of a particular type in dependence on the received command, where the installer plug-in module is arranged to install or uninstall computer programs of a single specific type.

According to a seventh aspect of the invention there is provided a computer program or suite of computer programs, so arranged such that when executed by a computer platform it/they cause the platform to perform the method of any of the above aspects. In addition, there is also provided a computer readable medium storing such a computer program or at least one of the suite of the computer programs.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram illustrating the typical hardware architecture of a smartphone and which may form the computing platform for example embodiments of the invention;

FIG. 2 is a block diagram of the components of a second example embodiment of the invention;

FIG. 3 is process diagram showing the steps and inter-communication performed in the second example embodiment of the invention;

FIG. 4 is a block diagram showing further details of the Software Component Registry (SCR) component of FIG. 2;

FIG. 5 is a block diagram showing further details of the Software Install Framework (SIF) component of FIG. 2;

FIG. 6 is a process diagram illustrating how additional installer plug-ins can be installed on the computer system post manufacture;

FIG. 7 is a diagram illustrating a computer readable medium storing code modules used in the second example embodiment.

### DESCRIPTION OF EXAMPLE EMBODIMENTS

Several example embodiments will now be described with respect to the drawings.

Many modern electronic devices make use of operating systems. Modern operating systems can be found on anything composed of integrated circuits, like personal computers, Internet servers, cell phones, music players, routers, switches, wireless access points, network storage, game consoles, digital cameras, DVD players, sewing machines, and telescopes. In one example an operating system is the software that manages the sharing of the resources of the device, and provides programmers with an interface to access those resources. In one example an operating system processes system data and user input, and responds by allocating and managing tasks and internal system resources as a service to users and programs on the system. In one example, at its most basic, the operating system performs tasks such as controlling and allocating memory, prioritising system requests, controlling input and output devices, facilitating networking, and managing files. In one example an operating system is in essence an interface by which higher level applications can access the hardware of the device.

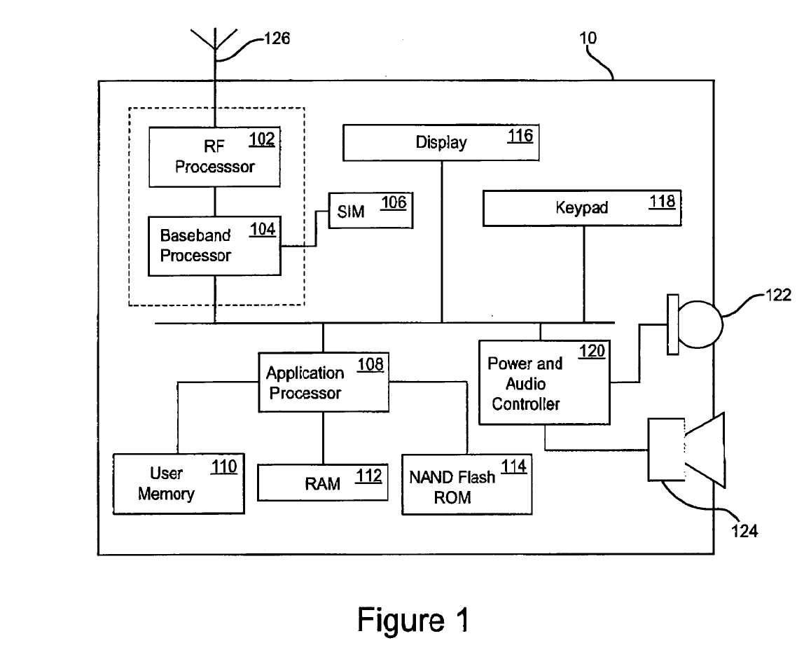

Many examples of modern electronic devices which make use of operating systems have as their basis a similar physical hardware architecture, making use, in some examples, of an application processor provided with suitable memory which stores the device operating system, as well as the higher level application programs which determine the functionality of the device. In some examples the operating system and other programs are typically stored in non-volatile Read-Only Memory, and the operating system is loaded first, to allow the application process to then run the higher level application programs. One very common modern electronic device which makes use of an operating system is a smartphone, an example generic hardware architecture for which is shown in FIG. 1.

With reference to FIG. 1, an example smartphone 10 comprises hardware to perform telephony functions, together with an application processor and corresponding support hardware to enable the phone to have other functions which may be desired by a smartphone, such as, for example, messaging, calendar, word processing functions and the like. In the example of FIG. 1 the telephony hardware is represented by the RF processor 102 which provides an RF signal to antenna 126 for the transmission of telephony signals, and the receipt therefrom. Additionally provided in this example is baseband processor 104, which provides signals to and receives signals from the RF Processor 102. In this example the baseband processor 104 also interacts with a subscriber identity module 106, as is well known in the art. The telephony subsystem of the smartphone 10 is beyond the scope of the present description.

Within this example also typically provided is a display 116, and a keypad 118. These are controlled in this example by an application processor 108, which is often (although not always) a separate integrated circuit from the baseband processor 104 and RF processor 102, although single chip solutions may also be used. In this example a power and audio controller 120 is provided to supply power from a battery (not shown) to the telephony subsystem, the application processor, and the other hardware. Additionally, in this example the power and audio controller 120 also controls input from a microphone 122, and audio output via a speaker 124.

Within this example, in order for the application processor 108 to operate, various different types of memory are often provided. Firstly, in this example the application processor 108 may be provided with some Random Access Memory (RAM) 112 into which data and program code can be written and read from at will. In this example code placed anywhere in RAM can be executed by the application processor 108 from the RAM.

Additionally provided in this example is separate user memory 110, which is used to store user data, such as, for example, user application programs (typically higher layer application programs which determine the functionality of the device), as well as user data files, and the like.

As mentioned previously, in this example, in order for the application processor 108 to operate, an operating system is necessary, which must be started as soon as the smartphone system 10 is first switched on. In this example the operating system code is stored in a Read-Only Memory, and in this example the Read-Only Memory is NAND Flash ROM 114. In this example the ROM will store the necessary operating system component in order for the device 10 to operate, but other software programs may also be stored, such as, for example, application programs, and the like, and in particular those application programs which are mandatory to the device, such as, in the case of a smartphone, communications applications and the like. In this example these would typically be the applications which are bundled with the smartphone by the device manufacturer when the phone is first sold. Further applications which are added to the smartphone by the user would usually be stored in the user memory 110, for example.

As noted previously, in an example computer system, including the smartphone 10, different types of executable code can be installed on the system, and historically, depending on the operating system type, the installation process for the executable is determined in dependence on the type of the executable code itself. For example, such software can be developed using various methods and programming languages, depending on the software's requirements and targeted delivery methods. On the other hand, users of the Operating System do not generally care about the development method of said software, but they do value the ability to list, execute and manage the software components on their system in a uniform way.

Since software differs significantly depending on its development and delivery methods (e.g. Java MIDlets, JavaScript Widgets, MS Windows native, Symbian OS native have different development and delivery methods, for example), it is a challenge for an Operating System to provide a uniform view while preserving the diversity of applications. Also, there is the challenge of preserving a system's security, e.g. allowing installation of JavaScript widgets that have a lower level of trust, without disrupting the security model of native applications that have a higher level of trust.

For example, in a Microsoft Windows Mobile device, installation of native applications (i.e. applications specifically developed for the Windows Mobile platform) is performed using a native installer module. Non-native code (i.e. code which has not been developed specifically for the platform, but which is generic across different platforms) such as Java MIDlets use separate installation manager entities. In addition, such executable code is not generally registered in a central registry, such that it is not possible for the device to provide a single interface to the user which allows a user to see all of the applications and other executable code that is installed on a device. The Windows Mobile solution requires developing several application and device managers for each software type. This impacts negatively on the user's convenience (as he/she needs to use multiple applications to achieve the same tasks), and the attractiveness for third parties providing managed execution environments and installers (such as for example Shockwave Flash, gaming engines etc.).

One operating system that does provides a common installation route onto a device using the OS is Linux, and particularly using the Red Hat Package Manager (RPM). RPM provides a uniform way for a user to install programs onto a Linux device, and also provides a database containing all of the meta information of the installed programs and multiple databases used for indexing purposes. The database is used to keep track of all files that are changed and created when a user (using RPM) installs a package, thus enabling the user (via RPM) to reverse the changes and remove the package later.

As well as providing the RPM database, RPM also provides a distribution package format for distributing executable code to Linux devices, irrespective of the code type. Hence, executable code of any type can be packaged using the RPM format, and then installed on a Linux device. The RPM database provides a record of what programs have been installed, and allows for easy un-installation, if required.

However, whilst RPM may provide a uniform way for installing programs on a device, this very uniformity means that it treats all code the same, and in particular in respect of the security requirements of the software that is being installed. For example, native software, Java MIDlets or game modules may all require different security checks and registrations at installation time, but the Linux solution provides only operations limited by its scripting language. A native application which has undergone extensive testing and development, for example, may be able to have access to more of the system's functions and hardware than generic code which has not been validated so highly. In addition, native code for which the development time has been reduced, for example game code or the like, such that extensive testing and security validation has not been possible, should not be treated the same as native code that has been extensively tested. However, by providing a common install route, RPM typically ignores security requirements such as these.

A first example embodiment of the invention will now be described.

More particularly, a first example embodiment provides an arrangement for the installation of computer programs of different types, such as, for example, applications, or other executable code such as JavaScript Widgets, Java MIDLets, or the like. In the first example embodiment a software installer framework module is provided that provides a single common installation interface with which the user and/or other applications can interface so as to cause computer programs to be installed or uninstalled from the platform. In the first example embodiment, by providing such a single common interface a uniform installation route onto the platform is provided.

In addition, within the first example embodiment in order to prevent security problems from treating every item of executable code the same, whether highly tested native code, or untested hobbyist code, the first example embodiment of the invention provides that the actual installation functions are provided by a plurality of plug-in installer modules, being for example at least one for each type of computer program that may be installed. For example, each installer is provided with appropriate security permissions relevant to the type of code that it is installing. For example, the installer for native code that will have been highly tested and has a greater degree of trust may have more security permissions in terms of the hardware and files that it can access. Conversely, for example, an installer for a type of game file that has a lower degree of trust has limited security permissions, and may only, for example, be allowed to install software to certain directories, and/or to contact certain particular game servers, and/or to access certain hardware or software resources on the computing platform. In the first example embodiment, by dividing the installation responsibilities into different installer plug-ins dependent on file type, then the security and reliability of the computing platform can be protected.

Within the first example embodiment a system for installing computer programs of different types on to a computer platform is provided. More particularly, the system of the first example embodiment comprises a software installer framework module providing an installation interface to cause an obtained computer program to be installed. The system also comprises a plurality of installer plug-in modules, being, for example, at least one installer plug-in module for each type of computer program to be installed. Within the first example embodiment each installer plug-in module is arranged such that in use it is able to install and/or uninstall the type of computer program to which it relates. The installation or un-installation takes place to and/or from the computer platform, as appropriate.

In order to cause installation or un-installation to take place, within the first example embodiment an install or uninstall command in relation to a specific computer program is received at the software installer framework module via the installation interface, and the software installer framework module then selects one of the plurality of installer plug-in modules to perform the installation or un-installation. In the first example embodiment the selection of a plug-in module is made in dependence on a type of the specific computer program, for example based on the Multipurpose Internet Mail Extensions (MIME) type of the program. Once selected, within the example embodiment the selected installer plug-in module then undertakes the installation or un-installation of the specific computer program to or from the computer platform. With such an arrangement the first example embodiment provides that a single installation route into the computing platform is provided, whilst maintaining the security and reliability of the platform.

Within the first example embodiment a single plug-in is provided for each software type. In other examples multiple plug-ins may be provided for each software type. However, by providing a single plug-in for each type, within the first example embodiment the plug-in selection process is simplified when a new install is to performed, as it is then only necessary to determine the type of the software to be installed, and then which plug-in to use is immediately apparent. This prevents having to make a further selection from a sub-set of installer plug-ins available for a particular software type.

Within the first example embodiment the system further includes a software component registry module having a database of the computer programs presently installed on the computing platform irrespective of type. This provides, for example, a single registry in which all computer programs installed on the platform can be recorded, and hence allows for easier access to such programs by the user, as well as by other programs.

Within the first example embodiment the software component registry module includes in its database data relating to the installer plug-in modules present on the computer platform, and the software installer framework module in use obtains from the software component registry module a plug-in ID of the one of the plurality of installer plug-in modules relating to a computer program type to be installed or uninstalled. Thus, within the first example embodiment even the installer plug-in modules are recorded in the software component registry, and the software installer framework selects the plug-in to be used by consulting the list of installed plug-ins in the registry.

The first example embodiment also includes an application visualisation module arranged in use to display to a user the computer programs installed on the computing platform. In this respect, in the example the application visualisation module interacts with the software component registry module to obtain information relating to the installed computer programs for display. This allows, for example, all of the computer programs installed on the platform to be displayed to the user using a single application. In addition, within the example the user can also select programs to be run from the display, and hence an integrated visualisation and execution display is provided.

Within the first example embodiment there is further provided a software transaction services module which, in use, records transactions on a file-system of the computing platform in which installed computer programs are stored. This allows, for example, for the installation process of the specific computer program by the selected installer plug-in module to be recorded. In the example embodiment recording the installation process allows rollback of the process in the event of any errors or power interruption during the process. Moreover, in the example embodiment the record of the installation process is used by the installer plug-in module to uninstall, or at least partially uninstall, the specific computer program when required.

Within the first example embodiment one or more security policies associated with the installer plug-in modules are provided. A security policy in the first example embodiment comprises data defining which resources of the computing platform a computer program that has been installed by a particular installer plug-in module may access. For example, an installer for a game program or script program has a security policy that specifies fewer resources of the computing platform that a computer program installed by the installer may access. For example, the security policy may define areas of storage on the device that may not be accessible, for example particular drives or directories. In addition the security policy may define particular resources or servers that may not be accessible. For example, the telephony resources may not be accessible, or other networking resources, such as LAN ports, or short-range wireless connections. Any resource of the computing platform, whether a hardware, software, or communications related resource, may be the subject of a security policy.

In one example the security policy may be defined positively, in that it defines what resources a computer program installed by a particular plug-in may access. In another example the security policy may be defined negatively, in that it defines what resources a computer program installed by a particular plug-in may not access. In an example, an installer plug-in module that relates to computer programs of a type that are more trusted, such as, for example, native applications that have been rigorously tested, will have a security policy that allows access to more resources of the computing platform. Conversely, in an example, an installer plug-in module that relates to a less trusted type of computer program, such as a game program or script program, will have a security policy that allows access to less resources.

In the first example embodiment, therefore, the level of access to the computer platform resources provided to a computer program is defined by the security policy associated with the installer plug-in module that installs the computer program. In this way security of the computing platform can be maintained.

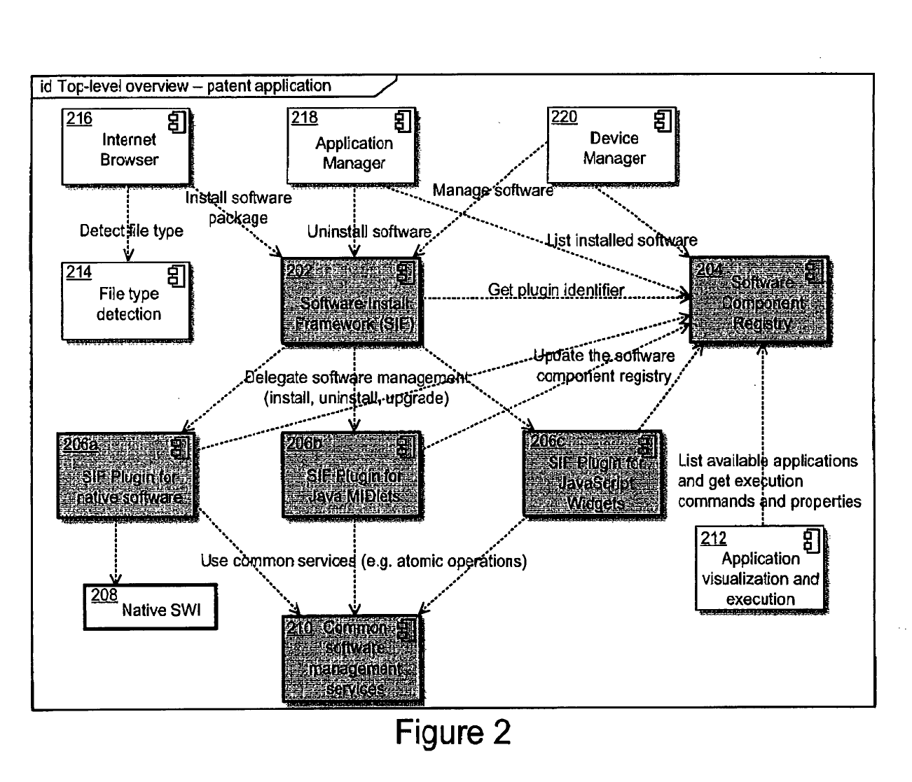

A second example embodiment will now be described in detail, with reference to FIGS. 2 to 6. However, before embarking on a detailed description of the second example embodiment, a brief overview of the elements of the second example embodiment and their operation and interaction will be given.

The second example embodiment of the invention provides a series of modules each of which perform a particular function. For example, the modules are run on a computing platform that provides the operating environment of the embodiment. In the second example embodiment the computing platform is the smartphone 10 described previously, but in other example embodiments other types of computing device, such as laptop or desktop computers, video games consoles, A/V devices such as MP3 players or set-top boxes may be used. For example, any computing device onto which programs such as applications or other executable code can be installed may be used as the computing platform of example embodiments.

The second example embodiment introduces a framework of components designed for managing a common software lifecycle across an Operating System. For example, by identifying a set of services and properties common to all software on an OS, the example embodiment allows uniform management and usage while still allowing diversity.

FIG. 2 shows the main entities and interactions of the second example embodiment. The main entities forming the second example embodiment. are shown in bold with a grey background, while other OS components participating in the example embodiment are shown with a white background.

More particularly, as shown in FIG. 2, the example embodiment makes use of several existing operating system entities and applications, such as, for example, internet browser 216, application manager 218, device manager 220, and file type detection module 214. Amongst other functions, the internet browser 216 allows the downloading and installation of new software components, for example. The example embodiment also allows the browser to install new software component types seamlessly, without doing any code changes. For example, by first detecting the file type, then identifying the appropriate handler for the file, the browser is able to delegate the installation to the Software Install Framework (discussed below) without being required to provide any special handling code.

In the present second example embodiment the file type detection module 214 provides a generic mechanism for establishing a file type. For example, the detection module typically determines the MIME file type, using the MIME standards, as is well known in the art. As such this component and its interaction with the Internet Browser are common for Operating Systems.

In the example embodiment the Application Manager 218 lists all installed software, and allows the user to remove particular software packages. In the example, by using the unified Software Component Registry (described further below), a single application manager can be developed for the OS, instead of having several application managers for each component type. Additionally, within the example by using the SIF (Software Install Framework), a single application manager can support new software types without doing any special new logic for uninstall.

In the example embodiment the device manager utility 220 allows the uninstalling and installing of software by remote commands or by a predefined schedule. Similarly to the Application Manager, in the example a single Device Manager can exist in the OS supporting an unlimited number of component types.

The main elements of the present example embodiment are the Software Install Framework (SIF) 202 and associated plug-ins 206. By way of example, FIG. 2 illustrates three plug-in modules, being a plug-in for native software 206a, that is used to install software native to the computing platform, a Java MIDlets installer plug-in 206b, for handling the installation and un-installation of Java MIDlets, and a JavaScript Widgets installer plug-in 206c, for handling the installation and un-installation of JavaScript Widgets. Other plug-ins for other executable code types may also be provided, for example, and may be installed on the device post manufacture. Later, the installation process for additional installer plug-ins for different code types will be described.

Within the example embodiment the software install framework module 202 (hereafter SIF) provides common and extensible interfaces for software installation management. It uses the Software Component Registry (described below) to select the appropriate plug-in for a particular operation. The plug-in acts as a separate application, and implements its own interaction with the user during the course of the installation. In one example, several plug-ins with different user interactions can coexist for the same software type (e.g. a silent and a GUI native installer). However, in another example a single plug-in is provided for each software type, as this simplifies the plug-in selection process when a new install is to performed. Within the present second example embodiment the SIF uses an extensible plug-in framework to allow seamless and secure addition of new installer implementations. The example embodiment allows delivery and removal of new SIF plug-ins during a system's lifetime. The central SIF module then concentrates on the properties and interfaces common to all software while delegating the installation and un-installation operations to the plug-ins. Thus, for any particular code-type, within the example the usual installation and un-installation operations required for that code type are performed by the plug-in, rather than by the SIF module.

Additionally provided by the second example embodiment is a common software management services module 210. This provides a number of Software Transaction Services (STS) which allow the atomic reversal of cancelled or unexpectedly aborted software management operations. For example, the STS allows common transaction management while segregating operations done by different installers. For example, this prevents a lower-trusted installer (such as a free Perl installer) from registering operations on the behalf of a higher-trusted installer (e.g. Java MIDlet).

For example, the Software Transaction Services provide transactions on top of the non-journalled operating system file-system. Installers (SIF Plugins) can start new transactions, for example, and roll them back atomically in case of a cancelled installation/uninstall/upgrade. By way of example, typical operations in a transaction might include “add file X, remove file Y, add a temporary file Z”. In such case, the roll-back of the transaction might be, for example, “delete file X, restore file Y, delete file Z”. If the transaction is committed, the operation would be deleting file Z. Typically, for example, the implementation of the STS may be based on the existing software install (SWI) services, where a centralised set of journal files is typically maintained for each modified drive.

A further component of the example embodiment is the Software Component Registry (SCR) 204. In the example embodiment this component provides a single point for retrieving and managing the status of all installed software in the OS. For example, it provides both properties common to all software (such as name and vendor) and mechanisms for recording properties unique to an environment (such as Java security domain). In the example embodiment this component provides a security model to allow co-existence of highly trusted software installers (i.e. SIF plug-ins) and less trusted ones, enabling different time-to-market paths and abilities across software types. For example, a 3^{rd} party can develop a gaming engine as a SIF plug-in with limited abilities, which would not require as rigorous a scrutiny as a native software installer. The former plug-in can only install software which displays graphics and contacts game servers, for example, while the latter has no limits on the software it can deliver. Further details of the SCR and its operation will be given later.

Finally, the last component to be mentioned in the second example embodiment is the application execution and visualization component 212. This OS component for example displays (usually graphically) the list of applications the user can execute and provides mechanisms for said execution. In the Windows OS, for example, this component (also known as Windows Explorer) manages the desktop and the Start Menu icons. In Linux, for example, this is a part of the Window subsystem (e.g. KDE). In Symbian OS, for example it is part of the Application Architecture. Within the present example embodiment because there is a central software registry, the SCR 204, it is then possible to have a single such component 212, for example, that interacts with the SCR 204 so as to be able to display and run seamlessly executable applications regardless of the method that was used to deliver the application to the device, and further regardless as to whether they run natively or using a managed execution environment (such as Java Virtual Machine).

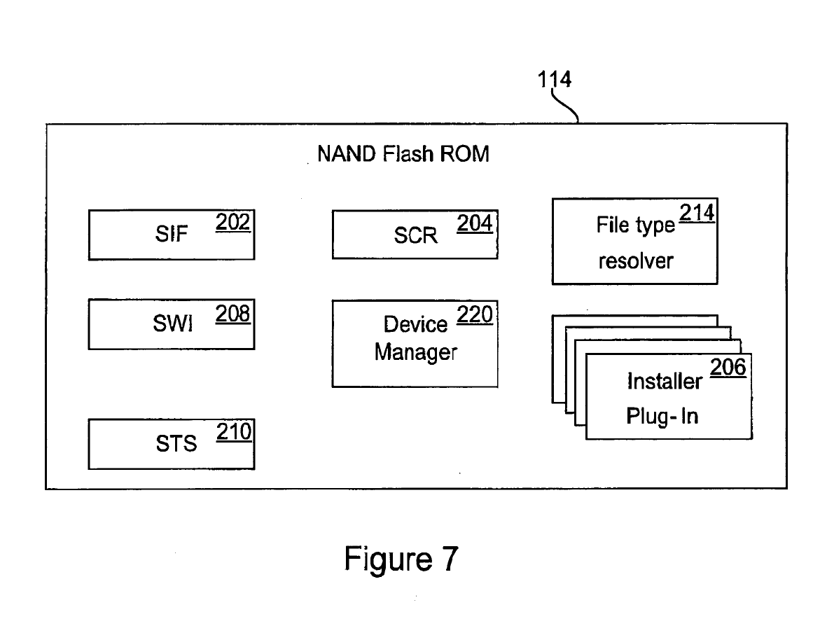

Within the present second example embodiment software code modules are provided corresponding to the above components, and which when run on a processor provide the component functionality. When, as in the present example embodiment, the computing platform is the smartphone 10, within the present example embodiment the code modules are typically stored in the NAND Flash Rom 114, as shown in more detail in FIG. 7. In particular, FIG. 7 illustrates code modules corresponding to the above noted components of the present example embodiment stored on the NAND Flash Rom 114 of the smartphone 10.

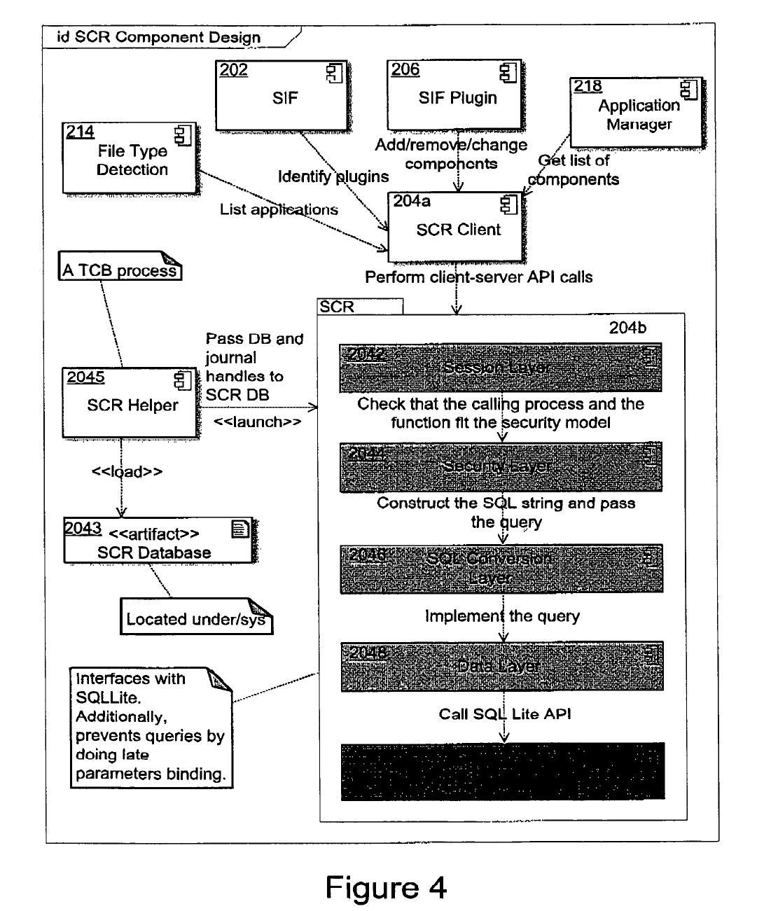

Further details of the SCR of the second example embodiment will be apparent from FIG. 4, which shows the various layers of functions provided by the SCR. In this respect, the SCR is responsible for managing the lifecycle of the following entities:
Software components
Installation environments and supported software types
Applications

In the second example embodiment software components are managed and displayed by application managers, device managers, and, last but not least, SIF Plugins, i.e. installers, whereas installation environments are managed by the native software installer 208. The SCR design of the second example embodiment must answer seamless support for different categories of clients, while keeping in mind performance and concurrency requirements, as well as security measures (discussed below).

In the second example embodiment the SCR itself is separated into layers with clear sets of functionality:
SQLLite layer 2049 for example provides database (DB) data management and allows DB and journal files to be supplied by handle.
Data layer 2048 is an SCR wrapper around the SQLLite APIs. For example, this separate layer allows switching to a different DB implementation or APIs if needed. Such a risk exists if SQLLite C APIs still prove insufficient for performance or security needs. The data layer also protects, for example, against SQL injection attacks by doing separate compilation of the SQL statements and binding of the parameters.
SQL Conversion Layer 2046 converts SCR API calls into SQL queries, for example. In the second example embodiment it includes most of the awareness regarding SCR entities in the component. In the second example embodiment it has a thin interface to the data layer which allows it to pass the SQL statement as a string.
Security Layer 2044 implements most of the security measures required, and discussed below. These include checking the identity of the calling process against the data being modified, for example.
Session Layer 2042 implements regular OS client-server maintenance on the server side.

Within the second example embodiment, in order for the SCR to function, an SCR database 2043 must be present. Since we cannot assume any pre-packaged database on the device, for example, within the example embodiment it should be created as necessary. To achieve this, in the second example embodiment the SCR Helper module 2045 is provided to create the DB if it does not find one, which under normal circumstances should happen on the first install, uninstall, or installed programs folder access, for example.

Within the second example embodiment the security of the SCR is very important. Threats to the SCR can appear from different attack vectors. The following is a non-exhaustive list:
Misusing SCR APIs.
   SQL injections.
   Using APIs not according to their intended purpose.
Modifying the database directly. This category applies to processes with AllFiles capabilities, as it is assumed in the second example embodiment that the DB is protected at least by a private directory. Cold-flash attacks also fall into this category.
   Accessing and writing to the DB file.
   Accessing and writing to the temporary journal file created by the DB.

The first attack vector above requires policing at the SCR in the second example embodiment, and involves several security measures.

The second attack vector applies in the second example embodiment regardless to the particular type of modification, and is countered as a whole—i.e. modifications to the DB which do not go through the SCR are prevented or at least detected, for example. Within the second example embodiment, to counter the threats to the SCR, the SCR implements a number of security measures (numbered as “SM”), as described in list form below, purely by way of example. The measures below relate to those which are most generally applicable in the second example embodiment. Other measures may be required in other example embodiments, depending on the particular operating system used. Moreover, in some example embodiments not all of the measures need be implemented or used at the same time, or in fact at all. In the examples below, the acronym TCB refers to the Trusted Computing Base, a Symbian OS term relating to the most trusted components of the operating system that have access to the hardware, and that is used solely by way of example. The Symbian TCB is analogous to the kernel in other operating systems, which may be used in other example embodiments.

SM01: No SCR APIs allow SQL parameters. Additionally, the SCR is designed to abstract the SQL layer from the API-s, and adds an escaping layer on all parameters before creating the SQL query.
SM02: SQLLite Client APIs prepare and compile SQL statements before processing the parameters.
SM03: SCR API: Components and common SCR properties may be added, updated or deleted only by n component-matching installation environment. The policing is done by comparing the SID of the client with the SID of registered installers for component's software type in the SCR.
SM04: SCR API: Component properties may be updated, added or deleted either by a component-matching installation environment, or corresponding execution environment (for managed software, e.g. JVM). No other executable on the device can perform these operations. The policing is done in a similar way as with SM03.
SM05: SCR API: File registration for components may be done only by the same entities as with SM04. Same policing mechanism is done.
SM06: SCR API: Software types and installation environments may be updated, added or deleted by the native software installer native SWI 208 only. Policing is done based on SWI UID.
SM07: SWI: The list of claimed MIME types is registered in a pre-defined resource file in the installation package. The target location of the resource file is not limited. If a SIF Plugin is delivered and the file is absent, SWI will reject the installation. If the file is present, SWI will parse the claimed MIME types, and check whether they are registered with the SCR. If not, SWI will register the new types and the environment with the SCR and will proceed with the installation as usual. If yes, SWI will check the UID-s and the trust levels of the installation environments which already claim the MIME types. Let's call the package being installed package A, and the set of existing installation environments for the MIME type packages B1, . . . Bn, where package B1 is the default installation environments (i.e. with no opaque, i.e. special, options). SWI will allow installation if and only if one of the following conditions are true:
1. A is a correct SA/PU of a package Bi and has the same opaque options as Bi. (SA/PU upgrade to native software is allowed to overwrite the original files, and cannot be uninstalled separately)
2. A is a correct SP of a package Bi and has different opaque options than Bi. (SP upgrade to native software is not allowed to overwrite files, but is allowed to be uninstalled separately)
3. A is not less trusted than package Bi and has the same opaque option as Bi.
4. A is not less trusted than package B1 and has different opaque options than all packages in B1 . . . Bn. (This means that all installation environments are at least as trusted as the default one)

If the installation is approved, SWI will update the list of installed environments and supported software types and tables at SCR. In addition to the rules above, SWI does not allow adding installers which register the SIS MIME type, i.e. no post-market installers for native software are allowed.

SM08: SCR API: An installer cannot claim that its package owns a file if an installer for another software type has already claimed the same file. A different installer of the same software type may claim the same file in the SCR. This check applies to files under /private and under /sys, since public data files do not have any protection at the OS level, and allowing their registration may allow lower-trust installer to block operations from higher-trust installers. This verification is done by the SCR before submitting the update to the DB.
SM09.1: Also, another measure to prevent denial of service on SWI operations is not to consider registrations belonging to other components in SWI operations. This means that SWI looks only for files registered to native components when try to check ownership and dependencies. SWI will treat these files as “orphaned”, i.e. not having an owner and will invoke corresponding UI notifications.
SM10: SCR: Writable transactions in the DB do not lock the DB for concurrent read throughout the installation/upgrade/uninstall process. During commit the DB is locked for read.
SM11: STS is a trusted computing base (TCB—the core of the operating system, referred to in non-Symbian OSs typically as the kernel) process which maintains journals in the TCB (\sys) area.
SM12: For each incoming journaling request, STS validates the data caging rules. It prevents processes from registering operations which violate the private data cage (e.g. deleting a file which does not correspond to the SID), and prevents registering operations in the \sys directory for non-TCB processes.
SM13: SIF is implemented in a separate process and SIF APIs go through client-server boundary.
SM14: SIF passes the security context of its callers to the SIF Plugins, allowing them to make security decisions based on the invoker of SIF.
SM15: The DB file is held in a TCB-protected directory under the /sys directory tree. A small TCB process, SCR Helper, loads the file in a writeable mode and passes it by handle to the SCR. The identity of the SCR is established by the SCR Helper via the ProtServ capability and SID (see SM16). This prevents files with the AllFiles capabilities (i.e. the ability ton access any file) from modifying the DB file directly.
SM16.1: SQLLite is used in a client mode. This prevents the file handle to the SCR DB from escaping the process. Only TCB processes and SCR can access the database at all times.
SM16.2: SCR Helper creates a DB journal file locally and passes it by handle to the SCR, which passes it to the SQLLite library. A special wrapper is developed around SQLLite library which enables this functionality and prevents SQLLite from creating such a file dynamically in the working directory. This prevents non-TCB processes (apart from the SCR) from modifying the DB journal file.
SM17: SCR does not store directly any manifest data. It only allows installers to register a path for the controller in the DB. This avoids cases where a malicious/badly written installer gains access to a controller belonging to a different software type, since even if that installer gets the path to the manifest file, it would still need to go through the regular data caging checks.
SM18: SCR does not allow an installer process to register files for a software component where the filename corresponds to a protected directory that the installer is not permitted to update.
SM19: SIF is implemented as a plug-in framework, where each SIF plug-in is limited according to the capabilities it was granted. For example, a Java installer can implement its security model, but it is limited to the capabilities and data caging rules the installer itself has.
SM20: When selecting SIF Plugins, SIF relies on file type MIME recognition and not on information reported directly by plugins.
SM21: SCR APIs allow the application manager to display the software type for an application (e.g. a specific icon for MIDLets). This allows the user to distinguish applications while choosing the software to be uninstalled.
SM22—SCR API: Transaction management is allowed only for registered installers or execution environments.
SM23—SWI does not consider components from other software types while doing any checks during the installation
SM24: SCR has the ProtServ capability and a reserved SID. It is not updatable via ROM stubs. This provides two layers of protection. SWI will not allow any package to eclipse the SCR, unless it is signed by the manufacturer specifically for that purpose. Having a reserved SID will prevent 3^{rd} parties without an ACS publisher id from signing SCR updates. Also, having the ProtServ capability prevents unsigned packages from implementing SCR. SCR Client validates that the server it connects to has the SCR reserved SID. This prevents malicious ProtServ processes with a different SID to masquerade themselves as the SCR.

Thus, in the second example embodiment the SCR is able to provide a protected database containing information relating to applications and other executable code that have been installed on the device. For example, the SCR is used during the installation process for new code to determine which plug-in the SIF module requires to install or uninstall an executable. In addition, the SCR can for example be accessed by the application visualisation and execution module 212 to provide a list of installed executables for display to the user, and from which the user can select to cause as executable to be run.

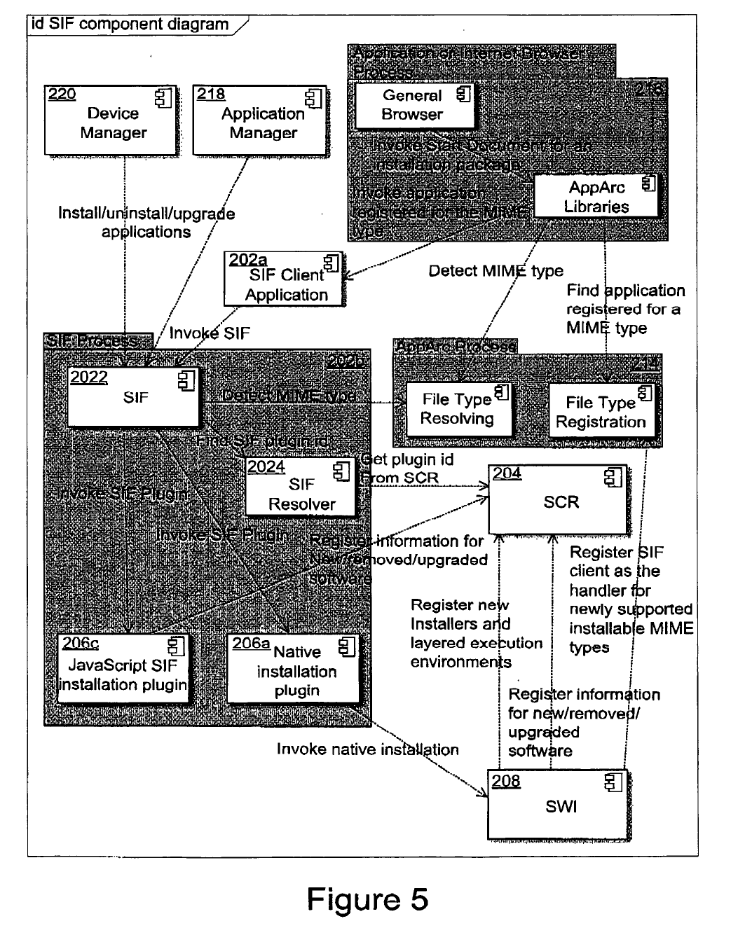

Further details of the SIF module of the second example embodiment are shown in FIG. 5. In particular the SIF module 202 of the second example embodiment further includes a SIF Resolver 2024 that performs the installation file type resolution either according to the MIME type, or according to the software component unique identifier. The second case applies to un-installations. The diagram also shows, by way of example, both a JavaScript installer plug-in, and the Native installation plug-in. Other plug-ins for other code types are not shown but are of course possible. In the present example the native installer plug-in 206a relies on the native software installer 208 to install native application. The native SWI 208 will be present already in the OS, for example. Other plug-in types will typically have their own installer functionality, for example, for installing and un-installing the type of code to which the plug-in relates. Plug-ins may be installed when the computing device which provides the platform for the present embodiment is manufactured, for example, or may be installed post-manufacture, for example by the user.

Within the present example embodiment the feature of post manufacture installer management provides the ability to add and remove new software environments (such as Python scripts, for example) after the device has been manufactured and delivered to the user. This feature is useful, for example, in the light of a recent tendency to move to post-production product and media services.

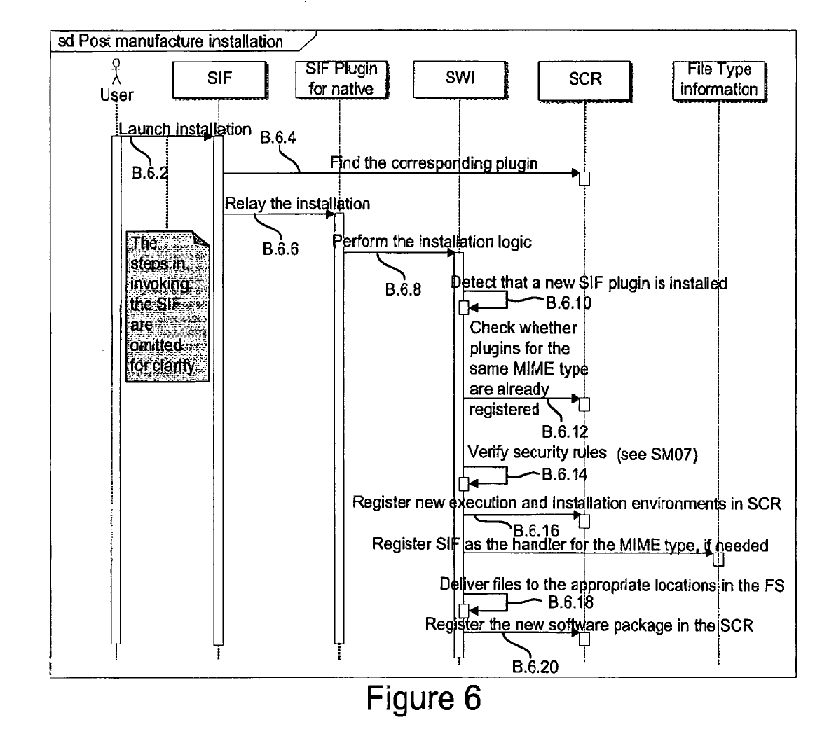

More particularly, within the second example embodiment for a new plug-in it is assumed that both the installer in the plug-in and any new execution engine for new environments are written in native API-s. There is no requirement in the second example embodiment to remove all associated software once the relevant environment has been removed. For example, there is no ability to remove all JavaScripts if the JavaScript engine and installer have been removed by the user. FIG. 6 shows the sequence diagram of the sequence of events that occur in installing a new plug-in in the second example embodiment.

By way of example only, the procedure of FIG. 6 assumes that the SIF component module is already running, and that the user has instructed the module to perform an installation of the new plug-in, for example that has been downloaded. Thus, within the second example embodiment the user instruction to install the new plug-in is received by the SIF module at block 6.2. Next, at block 6.4 the SIF module contacts the software component registry 204 to find the corresponding plug-in to be installed i.e. where the downloaded plug-in is stored. Next, because, as noted above, the plug-in is in native code to the platform, then the SIF will use the native plug-in 206 to perform the installation. Therefore, at block 6.6, the native plug-in is launched, and the installation relayed thereto, at block 6.6. In the present example embodiment, the native plug-in relies on the native software installer 208, which is the native software installer inherent in the operating system forming part of the computing platform. Therefore, at block 6.8 the SIF native plug-in instructs the native software installer 208 to begin the installation of the new plug-in i.e. to start to run through the installation logic to ensure that the plug-in files are copied to the appropriate place in the file-system. The software installer during this process monitors itself to confirm that the SIF plug-in becomes installed in the correct place, at block 6.10.

Within the present example embodiment, as one of the first steps in the installation process at block 6.12 the native software installer 208 checks with the software component registry 204 as to whether any other plug-ins for the same MIME type have already been registered; this check is performed at block 6.12, and then the results of the check are used in the security rules described previously as security measure 07 (SM07). These security rules are performed in the present example at block 6.14, and are to ensure that a plug-in for the MIME type of code to which the plug-in relates has not already been registered, for example.

Within the second example embodiment, provided that the security rules are passed, then at block 6.16 the new execution and installation environments corresponding to the plug-in are registered in the software component registry 204. For example, this involves creating a new database entry in the SCR database relating to the plug-in, and also to any other associated programs relating to the new execution environment that has been installed, if any. Next, if necessary, the SIF module is registered as the handler for the MIME type and, if required, this registration is performed with the file type detection module 214, for example.

The installation then continues at block 6.18, with the software installer 208 of the second example embodiment delivering the files of the installation to the appropriate location in the computing platform file system i.e. storing the installation files in the appropriate directories, and then registering any new software packages that have been installed with the files in the software component registry, at block 6.20.

Thus, with the above, the second example embodiment provides that new plug-ins and execution environments can be installed, together with new executable code that uses the execution environments. This allows for new execution environments, such as, for example, new versions of Java or Flash to be installed on a computing platform post-manufacture, and for a plug-in to be provided which runs with the execution environment, and allows new executable code which runs using that environment to be installed using the software installation framework of the present example embodiment. Hence, a computing platform using the present example embodiment of the invention can be updated with new software and execution environments during its lifetime.

Thus far, we have described the components of the present example embodiment, and how those components can be updated. To recap, the present example embodiment provides a software install framework module 202 which provides, for example, the basic interfaces to allow a user to install new executable code on a computing platform. However, the actual installation of new executable code is performed in the example embodiment by a respective plug-in dependent upon the code type. For example, each plug-in has the functionality required to install or uninstall the executable code, and each plug-in can, for example, implement a different security policy, dependent upon the type of the executable code. This allows executable code to be developed much more quickly, for example, without the code having to be thoroughly tested for reliability and security. Instead, within the example embodiment depending on the code type the appropriate plug-in which itself will have access to parts of the computing platform dependent upon its security level can be used to install the executable code, thus ensuring that security provisions are not breached.

Thus, for example, in the present example embodiment a native software installer, which will have access to all parts of the computing platform, is not used to install non-native code which has not undergone extensive testing. Instead, a plug-in relevant to the non-native code is used. In this respect, different software types can have different security attention and quality assurance, creating varying risk levels. For example, native software which is omnipotent on the system may have highly trusted and extensively analysed installers, whereas a script installer may for example be written by a lone hobbyist, and the scripts it delivers may have far more limited abilities. The software install framework of the present example embodiment allows such diverse software types to co-exist peacefully on the same computing platform, whilst still respecting the security of the platform.

In particular, in the present example embodiment, the various software installers are provided with security policies that define the level of access each has to the resources of the computing platform. The security policies may deal with access to hardware resources such as, for example, telephony services, network services, or audio and video input and output devices, as well as storage and memory, or may deal with access to software resources, such as particular servers or applications running on the computing platform, such as, for example, email applications, calendar applications, diary applications, or contacts applications.

When a computer program is installed by an installer, within the second example embodiment the permissions or capabilities of the installed program in terms of its ability to access resources of the computing platform are then defined or inherited from the installer module that installed the program. In this way, by controlling the security permissions and capabilities of the installer modules, the ability of installed computer programs to access platform resources is also controlled.

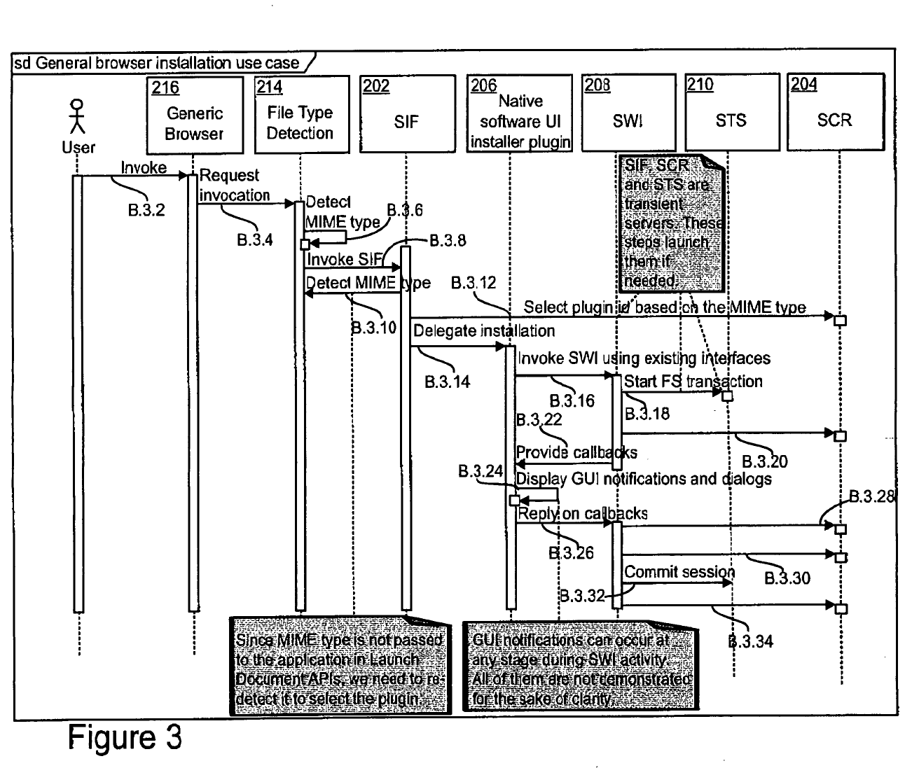

So far in respect of the second example embodiment we have discussed each of the components and their functionality, but we have not yet described an example of how the installation framework is used to install a new application, or other piece of executable code. However, the sequence of tasks performed by the software installation framework in so doing in the second example embodiment is shown in FIG. 3.

At a general level, the installation procedure of the second example embodiment involves the following. Firstly, the user will typically be running an existing application which is able to detect and cause to be installed new executable code, for example. This could be, for example, a generic internet browser, which is able to download applications and other executable code from the internet, for installation on the computing platform.

Next, within the second example embodiment when the user determines that he wishes to install the new application or other executable code, then the type of the code must be determined, and thereafter the software install framework selects the plug-in type in dependence on the type of the code to be installed. For example, it will be recalled that for each executable code type there is a plug-in which contains the functionality to be able to install and uninstall the particular type of code.

Having detected the plug-in type, within the second example embodiment the software install framework invokes the plug-in, which begins to run, and perform the installation. For example, in the case of the installation of native code, then the native installer plug-in may run the native software installer 208. However, for other types of executable code, the plug-in itself will contain the installer functions.

Within the second example embodiment installing a program via the plug-in typically involves three operations. Firstly, it involves installing the actual files of executable code to the appropriate parts of the computing platform file system. This is to make sure, for example, that the executable code is actually physically installed in the file system, and accessible by the computing platform.

Secondly, in order to keep track of the installation, and allow roll back thereof, and un-installation, within the second example embodiment the file system transactions are monitored by the software transaction services module 210. This keeps a log of file system transactions during the installation, for example, allowing the installation to be rolled back, or uninstalled, when required.

Thirdly, to reflect the installation within the second example embodiment the plug-in updates the software component registry, and in particular a new database entry is formed in the software component registry database, to reflect the newly installed application or other executable code. With these three tasks performed, within the second example embodiment the plug-in will have successfully installed the new application or other executable code, and that installation will have been journalled by the software transaction services module 210 such that it can be uninstalled if required. In addition, in the example embodiment the installation will have been recorded in the software component registry, such that all of the applications and other executable code installed on the computing platform are visible therefrom, for example.

With the above in mind, FIG. 3 illustrates the sequence of operations performed by the various components of the present example embodiment in installing a new native application. In this respect, the sequence of FIG. 3 relies upon the native software installer, and the native software installer 208. If a different type of application or executable code were to be installed, for example, which was non-native, and which therefore used the installation functions provided in the non-native plug-in, then the operations performed by the native software plug-in 206 and the native software installer 208 would be conflated.

Referring to FIG. 3, within the second example embodiment first let us assume that a user is using a generic browser 216, which the user has invoked at block 3.2. Using the generic browser the user determines, for example, that she wishes to install a new application or other executable code that she has downloaded. Within the present example the browser 216 then determines the file type of the application or other executable code at block 3.4, using the file type detection module 214, for example. Within the present example the file type detection module 214 detects the MIME type of the downloaded file at block 3.6, and next invokes the SIF module 202, at block 3.8. Within the present example the SIF module needs to re-detect the file type in order to invoke the correct plug-in, and this is performed at block 3.10. Then, having determined the MIME type of the file to be installed, within the present example the SIF module 202 contacts the software component registry 204, to find out the plug-in ID to be used based on the file MIME type. Within the example the SCR 204 returns the correct plug-in ID based on the MIME type passed to it by the SIF module, and then the SIF module launches the correct plug-in, and delegates the installation thereto at block 3.14. In the present example shown in FIG. 3 it is native code that is being installed, and hence the native software installer plug-in 206 is launched. However, in other examples if non-native code was being installed, then the plug-in relevant to the file type would be installed e.g. a JavaScript Widget installer, or the like.

In FIG. 3, because the present example embodiment relies on native software, the native software installer plug-in 206 calls the native software installer 208, to actually perform the installation. As noted, however, in other examples for other file types, the installer plug-in for that file type would perform the installer operations. In the present example embodiment the installer operations comprise block 3.18 and block 3.20. In particular, at block 3.18 the installer plug-in starts a file system transaction with the software transaction services module 210. That is, in the present example embodiment the software transaction services module 210 is instructed to start recording file system transactions as the installation of the software takes place, by the plug-in. Likewise, within the present example the software component registry is instructed to start a SCR transaction i.e. to register that a new application or other executable code is being installed, and hence it should open a new database entry for the application or other executable code.

Next, in the present example the installer plug-in displays any appropriate notifications to the user at block 3.24, and gets user permission to continue with the installation, and this is reported to the software installer 208 at block 3.26. Of course, in the example GUI events to obtain user permission to proceed may take place at any required point through the installation procedure: only one such event is shown here for the sake of convenience. In other examples multiple such events may occur. Again, if another type of code was being installed other than native code, then all of the operations performed by the software installer 208 in the present example embodiment would be performed by the installer plug-in and hence there would be no need to report between the two entities.

Having received user confirmation to proceed, and with the software transaction services module 210 recording file system transactions, within the present example at block 3.28 entries are made in the SCR database to reflect the installation of application or executable code files, and at the same time those files are delivered and stored in the file system, in the appropriate directory or directories, at block 3.30. Thereafter, in the present example once the files have been copied to the appropriate part of the file system, and the software transaction services module journaling functions are complete, the journal entry for the installation made by the software transaction services module 210 is completed by the session being committed at block 3.32. Likewise, within the present example the software component registry database entries are also completed, by the installer committing the SCR session at block 3.34.

Thus, with the above, in the present example embodiment new applications or other executable code can be installed on the computing platform, using the software installation framework described.

Without in any way limiting the scope, interpretation, or application of the claims appearing below, a technical effect of one or more of the example embodiments disclosed herein is to provide a richer choice of development for the OS. Developers which emphasise time-to-market over performance may develop for a managed environment (such as Java or .NET) while knowing that their product will be as visible on the platform as one which has chosen a different set of priorities.

Another technical effect of one or more of the example embodiments disclosed herein is to improve the usability of the OS, as the users would not need to know or care in what wrapping their software came from. They will be able to use or manage the applications on their OS in the same way, with the same set of utilities and with the same visual cues.

Another technical effect of one or more of the example embodiments disclosed herein is the second example embodiment also enriches the eco-system of the OS, allowing developers with different technical backgrounds to develop for the OS while getting equal visibility for their software.

Another technical effect of one or more of the example embodiments disclosed herein is to add features in an enterprise environment. For example, system administrators may allow the user to install software which can do less damage to the system by limiting the set of installer plug-ins. This also means that the users would not have to make as many security decisions or need to be explicitly trusted by the enterprise.

Another technical effect of one or more of the example embodiments disclosed herein is to enable faster time-to-market for installer developers. For example, by using a common set of functionality in the OS, 3^{rd} party developers of SIF plug-ins can concentrate on the specific features of their application language or delivery mode.

Another technical effect of one or more of the example embodiments disclosed herein is the provision of a customizable install, for example the ability to perform additional operations during the install process according to the software type. For example, a MIDlet install may send messages to the network provider during install or uninstall (OTA protocol), or the native installer may implement complex upgrade rules etc.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1, and one example of a computer readable medium described and depicted in FIG. 7. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1.-26. (canceled)

27. An apparatus, comprising:
at least one processor; and
at least one memory including computer program code,
the at least one memory and the computer program code configured to, with the at least one processor, cause the apparatus to perform at least the following:
operate an installer plug-in module, the installer plug-in module being arranged in use to receive an install or un-install command from the software installer framework module, and to install or un-install a specific computer program of a particular type in dependence on the received command, where the installer plug-in module is arranged to install or uninstall computer programs of a single specific type.

28. An apparatus according to claim 27, further comprising a software component registry module having a database of the computer programs presently installed on the computing platform irrespective of type.

29. An apparatus according to claim 28, wherein the software component registry module includes in its database data relating to the installer plug-in modules present on the computer platform, and the software installer framework module in use obtains from the software component registry module a plug-in ID of the one of the plurality of installer plug-in modules relating to a computer program type to be installed or uninstalled.

30. An apparatus according to claim 28, further comprising an application visualisation module arranged in use to display to a user the computer programs installed on the computing platform, the application visualisation module interacting with the software component registry module to obtain information relating to the installed computer programs for display.

31. An apparatus according to claim 27, further comprising a software transaction services module which, in use, records transactions on a file-system of the computing platform in which installed computer programs are stored, whereby the installation process of the specific computer program by the selected installer plug-in module is recorded.

32. An apparatus according to claim 31, wherein the record of the installation process is used by the installer plug-in module to uninstall, or at least partially uninstall, the specific computer program when required.

33. An apparatus according to claim 27, further comprising one or more security policies associated with the installer plug-in module(s), wherein each security policy comprises data defining which resources of the computing platform a computer program that has been installed by a particular installer plug-in module may access.

34. A method, comprising:
a) receiving an install or uninstall command in relation to a specific computer program at an installation interface provided by a software installer framework module provided on a computer platform;
b) selecting, in dependence on a type of the specific computer program, one of a plurality of installer plug-in modules, being at least one installer plug-in module for each of one or more types of computer program to be installed, each installer plug-in module being arranged such that in use it is able to install and/or uninstall the type of computer program to which it relates to and/or from the computer platform; and
c) the selected installer plug-in module then undertaking the installation or un installation of the specific computer program to or from the computer platform.

35. A method according to claim 34, further comprising registering the installation or un-installation of the specific computer program with a software component registry module having a database of the computer programs presently installed on the computing platform irrespective of type.

36. A method according to claim 35, wherein the software component registry module includes in its database data relating to the installer plug-in modules present on the computer platform, the method further comprising obtaining at the software installer framework module and from the software component registry module a plug-in ID of the one of the plurality of installer plug-in modules relating to a computer program type to be installed or uninstalled.

37. A method according to claim 34, further comprising displaying to a user the computer programs installed on the computing platform via an application visualisation module, the application visualisation module interacting with the software component registry module to obtain information relating to the installed computer programs for display.

38. A method according to claim 34, further comprising recording transactions on a file-system of the computing platform in which installed computer programs are stored, whereby the installation process of the specific computer program by the selected installer plug-in module is recorded.

39. A method according to claim 38, wherein the record of the installation process is used by the installer plug-in module to uninstall, or at least partially uninstall, the specific computer program when required.

40. A method, comprising:
operating an installer plug-in module for use with the method of claim 34, the installer plug-in module being arranged in use to receive an install or un-install command from the software installer framework module, and to install or un-install a specific computer program of a particular type in dependence on the received command, where the installer plug-in module is arranged to install or uninstall computer programs of a single specific type.

41. A method according to claim 34, further comprising applying one or more security policies associated with the installer plug-in module(s), wherein each security policy comprises data defining which resources of the computing platform a computer program that has been installed by a particular installer plug-in module may access.

42. A computer program product or suite of computer programs comprising at least one computer readable medium having program code stored thereon, wherein the program code, when executed by an apparatus, causes the apparatus at least to:
operate an installer plug-in module, the installer plug-in module being arranged in use to receive an install or un-install command from the software installer framework module, and to install or un-install a specific computer program of a particular type in dependence on the received command, where the installer plug-in module is arranged to install or uninstall computer programs of a single specific type.

43. The computer program product or suite of computer programs according to claim 42, further comprising a software component registry module having a database of the computer programs presently installed on the computing platform irrespective of type.

44. The computer program product or suite of computer programs according to claim 43, wherein the software component registry module includes in its database data relating to the installer plug-in modules present on the computer platform, and the software installer framework module in use obtains from the software component registry module a plug-in ID of the one of the plurality of installer plug-in modules relating to a computer program type to be installed or uninstalled.

45. The computer program product or suite of computer programs according to claim 43, further comprising an application visualisation module arranged in use to display to a user the computer programs installed on the computing platform, the application visualisation module interacting with the software component registry module to obtain information relating to the installed computer programs for display.

46. The computer program product or suite of computer programs according to claim 42, further comprising a software transaction services module which, in use, records transactions on a file-system of the computing platform in which installed computer programs are stored, whereby the installation process of the specific computer program by the selected installer plug-in module is recorded.
